(19) United States
(12) Patent Application Publication
(10) Pub. No.: US 2019/0143589 A1
(43) Pub. Date: May 16, 2019

(54) POWDER BED DEVICE OF ADDITIVE MANUFACTURING AND ADDITIVE MANUFACTURING APPARATUS

(71) Applicant: METAL INDUSTRIES RESEARCH & DEVELOPMENT CENTRE, KAOHSIUNG (TW)

(72) Inventors: Hsiang-Pin WANG, Kaohsiung City (TW); Yen-Ting CHEN, Kaohsiung City (TW); Meng-Hsiu TSAI, Kaohsiung City (TW); Ying-Cheng LU, Kaohsiung City (TW); Chiu-Feng LIN, Pingtung County (TW)

(21) Appl. No.: 15/853,843

(22) Filed: Dec. 24, 2017

(30) Foreign Application Priority Data
Nov. 16, 2017 (TW) 106139768
Nov. 16, 2017 (TW) 106139769

(51) Int. Cl. B29C 64/245; B29C 64/153; B29C 64/295; B29C 64/307

(52) U.S. Cl. CPC B29C 64/245; B29C 64/153; B33Y 40/00; B29C 64/307; B29C 64/295

(57) ABSTRACT

A powder bed device of additive manufacturing, which comprises a housing, a powder bed platform disposed in the housing, and elevating devices, is provided. Height of elevating platforms of the powder bed platform is adjusted by the elevating devices, which are connected to the elevating platforms. Therefore, the filled range of powders may be controlled, thereby avoiding waste of the excess powders.

### RELATED APPLICATION

This application claims priority to Taiwan Application Serial Number 106139768, filed on Nov. 16, 2017 and Taiwan Application Serial Number 106139769, filed on Nov. 16, 2017, which are herein incorporated by reference.

### BACKGROUND

### Field of Invention

The present invention relates to a powder bed device of additive manufacturing. More particularly, the present invention relates to a powder bed device with elevating devices.

### Description of Related Art

Additive manufacturing (AM), also referred to as 3D-printing, is a process for material bonding. Steps of additive manufacturing include processing 3-dimensional modeling data under computer aided design (CAD), and a designed 3-dimensional diagram is sliced. And then, a material is heated by an energy source of additive manufacturing apparatus to be sintered molding and fused molding. After printing layer-by-layer, the 3-dimensional workpiece can be produced.

The material used in the additive manufacturing technique includes metal, polymer and ceramics. Generally, powders are often used as raw materials for the additive manufacturing, and the process cost of the additive manufacturing is mainly from the cost of powder material. Since the powders used in the additive manufacturing are fine powders with small average particle size, in which the cost of fine powders is almost ten times over cost of powders used in a conventional powder metallurgy. However, a conventional powder bed device of additive manufacturing has a working platform in a fixed dimension; thereby the powder material is necessary to fully cover the working platform whatever size of a workpiece is desired, and then the additive manufacturing process may be performed. In other words, in addition to a specific range of forming area, excessive powder material within the working platform only functions as filling up the platform. Obviously, waste of powder material is caused by the conventional powder bed device. Even though the unused powder material can be reused after recycling and sieving, a process of powder recycle is a waste of time, and the unused powder cannot be fully recycled; thereby part of the powder material in high cost is wasted inevitably. Moreover, the process of powder recycle is a manual operation, therefore, it is not only a waste of human resources, but operators are often occupational injured due to the powder inhalation.

Besides, in the additive manufacturing, sinter molding and fuse molding are performed by sequentially applying energy to stack powder layers. However, when an upper layer of the powder layers is processed, a lower layer of the powder layers, which has been processed, can conduct heat to the upper layer due to its higher temperature, such that a forming temperature of the upper layer is different from that of the lower layer due to the heat conduction. Therefore, the difference of the forming temperatures results in inconsistence in material properties between each layer, and quality of the formed workpiece is also affected. Moreover, if a temperature of the processed powder layer decreases sharply, buckling deformation is caused by an accumulation of thermal stress, thereby being unfavorable to stacking and processing of the following powder layers.

A heating element is disposed within a conventional powder bed of additive manufacturing to perform pre-heating to the powder bed. Therefore, problems of excessive temperature gradient due to heating powder in high speed, split of the formed workpiece caused by dramatic change in temperature, and buckling deformation due to residual thermal stress can be avoided in the laser sintering or laser melting process. However, as an increasing of the height of workpiece, heating efficiency of heating the upper layer with the heating element which merely heats from a bottom of the powder bed is reduced. Therefore, the defects of the temperature gradient between the upper layer and the lower layer are still not improved effectively.

In view of the foregoing, there is a need to provide a powder bed device of additive manufacturing to lower the cost of the powder material, and decrease the waste in processing time and human resource. Moreover, the temperature gradient between the powder layers can be decreased, and quality of the workpiece is improved.

### SUMMARY

An aspect of the present invention provides a powder bed device of an additive manufacturing, which adjusts a dimension of a powder bed platform according to a size of desired workpiece by elevating devices connected to elevating platforms of a powder bed platform.

Another aspect of the present invention provides a powder bed device of an additive manufacturing, which adjusts a dimension of a powder bed platform according to a size of desired workpiece by controlling a transmission element and pneumatic cylinders connected to enclosed elevating platforms of a powder bed platform.

Further another aspect of the present invention provides an additive manufacturing apparatus, which adjusts a dimension of a powder bed platform by elevating devices, use a distributor to distribute the powders on the powder bed platform evenly, and use a laser source for providing energy to the powder bed to perform additive manufacturing.

According to the aspect of the present invention, providing a powder bed device of an additive manufacturing, which comprises a housing, a powder bed platform disposed in the housing, and elevating devices. The powder bed platform is configured to load a powder bed, in which the powder bed includes powders. The powder bed platform includes at least two elevating platforms, in which each elevating platform at least adjoins the other elevating platform. The elevating platforms are linked or not linked with each other. The elevating devices are connected to a bottom surface of the elevating platforms, respectively.

According to an embodiment of the present invention, the powder bed platform is a combined annular platform. The elevating platforms include a first elevating platform located at a center portion of the powder bed platform, and a second elevating platform enclosed an outer sidewall of the first elevating platform.

According to an embodiment of the present invention, a top plate is disposed at a top portion of the powder bed platform, and the powder bed device further comprises heating elements disposed within the powder bed platform and the housing, in which the heating elements are adjacent to the top plate or a top portion of the housing.

According to an embodiment of the present invention, the heating elements are heating coils and/or heating ducts.

According to an embodiment of the present invention, the adjoining elevating platforms have an overlapped portion to jointly and vertically lift or lower the adjoining ones.

According to an embodiment of the present invention, the elevating devices include at least one transmission element and at least one pneumatic cylinder.

According to another aspect of the present invention, providing a powder bed device of an additive manufacturing, which comprises a housing, a powder bed platform disposed in the housing, a transmission element, and pneumatic cylinders. The powder bed platform is configured to load a powder bed, in which the powder bed includes powders. The powder bed platform includes a first elevating platform and a second elevating platform enclosed an outer sidewall of the first elevating platform. The second elevating platform includes sub-elevating platforms, in which one of the sub-elevating platforms encloses other one of the sub-elevating platforms, and a distance between the former and the first elevating platform is greater than a distance between the latter and the first elevating platform. The transmission element is connected to a bottom surface of the first elevating platform. Pneumatic cylinders are connected to a bottom surface of each of the sub-elevating platforms of the second elevating platform, respectively.

According to an embodiment of the present invention, the first elevating platform and the second elevating platform have an overlapped portion to link ascent and descent of the first elevating platform and the second elevating platform. The adjoining sub-elevating platforms of the second elevating platform have other overlapped portions to jointly and vertically lift and lower the adjoining ones.

According to an embodiment of the present invention, a top portion of the powder bed platform has a top plate, and the powder bed device further comprises heating elements disposed within the powder bed platform and the housing, in which the heating elements are adjacent to the top plate or a top portion of the housing.

According to an embodiment of the present invention, the heating elements are heating coils and/or heating ducts.

According to further another aspect of the present invention, providing an additive manufacturing apparatus, which comprises a powder bed device, a distributor disposed on the powder bed device, and a laser source. The powder bed device includes a housing, a powder bed platform disposed in the housing, and elevating devices. The powder bed platform is configured to load a powder bed, in which the powder bed includes powders. The powder bed platform includes at least two elevating platforms, in which each elevating platform at least adjoins the other elevating platform. The elevating platforms are linked or not linked with each other. The elevating devices are connected to a bottom surface of the elevating platforms, respectively. The distributor is used for distributing the powders on a top surface of the powder bed platform evenly. The laser source is used for providing laser energy to the powder bed.

According to an embodiment of the present invention, a top portion of the powder bed platform has a top plate, and the powder bed device further comprises heating elements disposed within the powder bed platform and the housing, in which the heating elements are adjacent to the top plate or a top portion of the housing.

According to an embodiment of the present invention, the heating elements are heating coils and/or heating ducts.

According to an embodiment of the present invention, the powder bed platform is a combined annular platform. The elevating platforms include a first elevating platform located at a center portion of the powder bed platform, and a second elevating platform enclosed an outer sidewall of the first elevating platform.

According to an embodiment of the present invention, the elevating devices include at least one transmission element and at least one pneumatic cylinder.

A powder bed device of an additive manufacturing of the present invention adjust height of elevating platforms by elevating devices connected to elevating platforms; thereby, fill-up range of powders can be controlled, and waste of excessive powders can be avoided.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a cross-sectional diagram of a part of a powder bed device of additive manufacturing according to an embodiment of the present invention.

FIG. 1B is a top view of a powder bed platform according to an embodiment of the present invention.

FIG. 1C is an enlarged diagram of part B in FIG. 1A.

FIG. 2 is a cross-sectional diagram of a part of a powder bed device of additive manufacturing according to another embodiment of the present invention.

FIG. 3 is a cross-sectional diagram of a part of a powder bed device of additive manufacturing according to an embodiment of the present invention.

FIG. 4A is a cross-sectional diagram of a part of a powder bed device of additive manufacturing according to another embodiment of the present invention.

FIG. 4B is a top view of a powder bed platform according to another embodiment of the present invention.

FIG. 5A, FIG. 6A and FIG. 7A are isometric views of the powder bed device of FIG. 1A fabricating a workpiece.

FIG. 5B, FIG. 6B and FIG. 7B are cross-sectional diagrams of the powder bed device of FIG. 5A, FIG. 6A and FIG. 7A fabricating a workpiece.

FIG. 8A, FIG. 8B and FIG. 8C are cross-sectional diagrams of the powder bed device of FIG. 2 fabricating a workpiece.

### DETAILED DESCRIPTION

According to the above, the present invention provides a powder bed device of additive manufacturing, which adjusts a dimension of a powder bed platform according to a size of a desired workpiece by elevating devices connected to elevating platforms of the powder bed platform.

The following embodiments are provided to better elucidate the practice of the present invention and should not be interpreted in anyway as to limit the scope of same. Those skilled in the art will recognize that various modifications may be made while not departing from the spirit and scope of the invention. All publication and patent applications mentioned in the specification are indicative of the level of those skilled in the art to which this invention pertains.

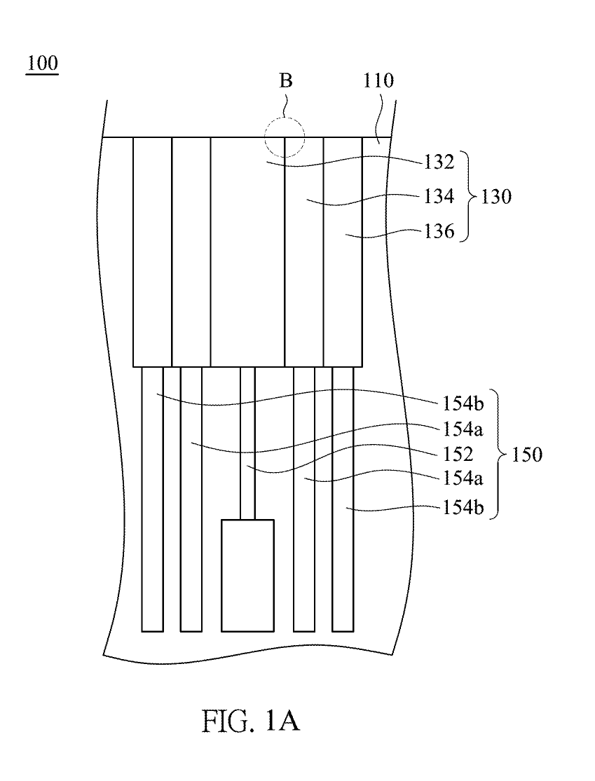

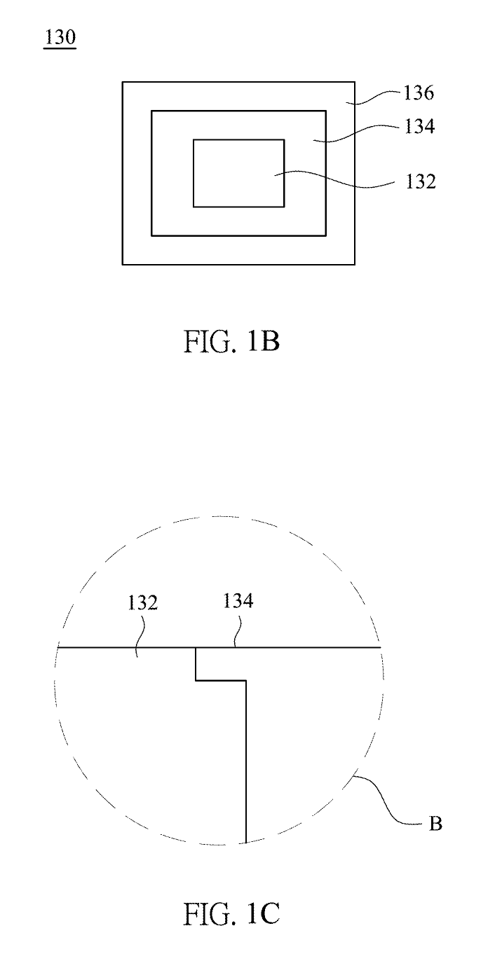

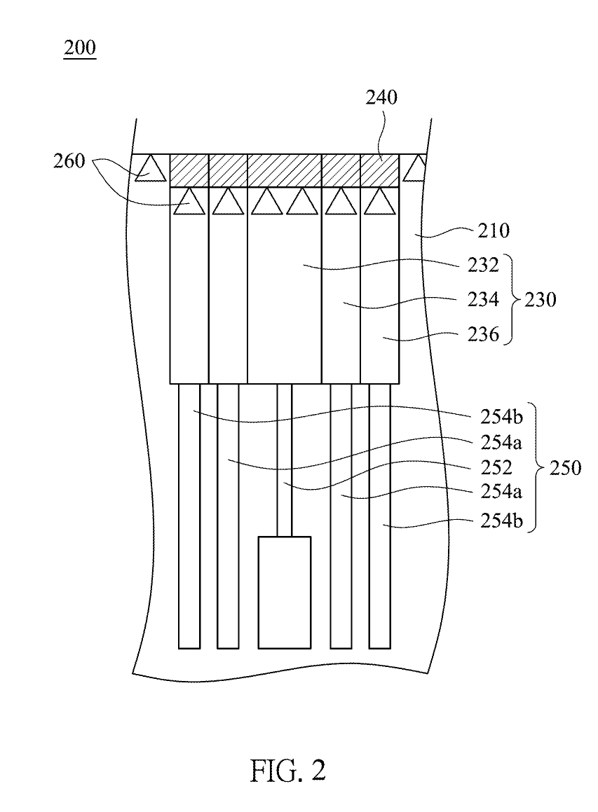

Referring to FIG. 1A, which is a cross-sectional diagram of a part of a powder bed device 100 of additive manufacturing according to an embodiment of the present invention. The powder bed device 100 comprises a housing 110, a powder bed platform 130 disposed in the housing 110, and elevating devices 150. The powder bed platform 130 is configured to load a powder bed, in which the powder bed includes powders. The elevating devices 150 are connected to a bottom surface of the powder bed platform 130 so as to control vertical ascent or vertical descent of the powder bed devices 130. In an embodiment, as shown in FIG. 1A, the elevating devices 150 include a transmission element 152 and two sets of pneumatic cylinders 154a and 154b. However, the configuration of the elevating devices is not limit to the configuration in the embodiment, but the elevating devices may be at least one transmission element and at least one pneumatic cylinder. In an example, the transmission element 152 is an element including a motor, a lead screw, a linear guideway, and etc. As shown in FIG. 1A, the powder bed platform 130 and the elevating devices 150 may be both disposed in the housing 110. In an embodiment, the elevating devices 150 may be optionally disposed outside the housing 110.

In an embodiment, the powder bed platform may be rectangular, circular or any suitable shape. In an embodiment, the powder bed platform includes at least two elevating platforms, and preferably includes more than or equal to three elevating platforms. In an embodiment, the powder bed platform includes a first elevating platform and a second elevating platform enclosed an outer sidewall of the first elevating platform, in which the second elevating platform includes plenty of sub-elevating platforms. One of the sub-elevating platforms encloses another one of the sub-elevating platforms, and a distance between the former one and the first elevating platform is greater than a distance between the latter one and the first elevating platform (for example, a first sub-elevating platform encloses a second sub-elevating platform; and a distance between the first sub-elevating platform and the first elevating platform is greater than a distance between the second sub-elevating platform and the first elevating platform).

FIG. 1B is a top view of the powder bed platform 130 according to an embodiment of the present invention. Referring to FIG. 1A together with FIG. 1B, the powder bed platform 130 is a combined annular platform in a rectangular shape. The powder bed platform 130 includes three elevating platforms, which are a first elevating platform 132, a second elevating platform 134 and a third elevating platform 136. The first elevating platform 132 is located at a center portion of the powder bed platform 130, the second elevating platform 134 encloses an outer sidewall of the first elevating platform 132, and the third elevating platform 136 encloses an outer sidewall of the second elevating platform 134. In an embodiment, based on an upper surface area of the powder bed platform 130 (i.e. upper surfaces of the first elevating platform 132, the second elevating platform 134 and the third elevating platform 136) as 100%, the upper surface area of the first elevating platform 132 is 30%, and the upper surface area of the first elevating platform 132 and the second elevating platform 134 are 60%. The area ratio is merely an example and not intended to be limiting.

Referring to FIG. 1A again, the transmission element 152 is connected to a bottom surface of the first elevating platform 132, a first pneumatic cylinder 154a is connected to bottom surfaces of opposite sidewalls of the second elevating platform 134, and a second pneumatic cylinder 154b is connected to opposite bottom surfaces of the third elevating platform 136. In an embodiment, an overlapped portion is at an adjoining position between the second elevating platform 134 and the first elevating platform 132, so that the second elevating platform 134 may jointly and vertically lift or lower the first elevating platform 132, selectively. In an embodiment, an overlapped portion is at an adjoining position between the third elevating platform 136 and the second elevating platform 134, so that the third elevating platform 136 may jointly and vertically lift or lower the second elevating platform 134, selectively. Referring to FIG. 1C, which is an enlarged diagram of part B in FIG. 1A. In the enlarged diagram, the overlapped portion between the first elevating platform 132 and the second elevating platform 134 is at top portions of the both, and the top portion of the second elevating platform 134 partially covers the top portion of the first elevating platform 132. Similarly, the top portion of the third elevating platform 136 partially covers the top portion of the second elevating platform 134. However, the top surfaces of the first elevating platform 132, the second elevating platform 134 and the third elevating platform 136 aligns with the same height. It is noted that, in the diagram of the FIG. 1A, a volume of the overlapped portion structure is much smaller than that of the powder bed platform 130. Therefore, the overlapped portion is not shown in FIG. 1A for the sake of clarity of discussion.

When the first elevating platform 132 is descended, by introducing gas to the second pneumatic cylinder 154b, but not to the first pneumatic cylinder 154a, the third elevating platform 136 is supported by the introduced gas in the second pneumatic cylinder 154b, and the bottom surface of the second elevating platform 134 is not supported by gas. Furthermore, the overlapped portion between the second elevating platform 134 and the first elevating platform 132 is not retained by the first elevating platform 132, such that the second elevating platform 134 can be jointly descended until the overlapped portion is retained by the fixed first elevating platform 132, thereby subjecting the height of the second elevating platform 134 to be substantially the same as the height of the first elevating platform 132. Similarly, when the first elevating platform 132 is descended, without introducing gas to the first pneumatic cylinder 154a and the second pneumatic cylinder 154b, neither of the bottom surfaces of the second elevating platform 134 and the third elevating platform 136 are supported by the gas, and the overlapped portions are not retained by the first elevating platform 132 and the second elevating platform 134, respectively. Therefore, the second elevating platform 134 and the third elevating platform 136 are both descended until the overlapped portions are retained by the fixed first elevating platform 132 and the fixed second elevating platform 134, respectively, so as to make the height of the second elevating platform 134 and the third elevating platform 136 are substantially the same as the height of the first elevating platform 132.

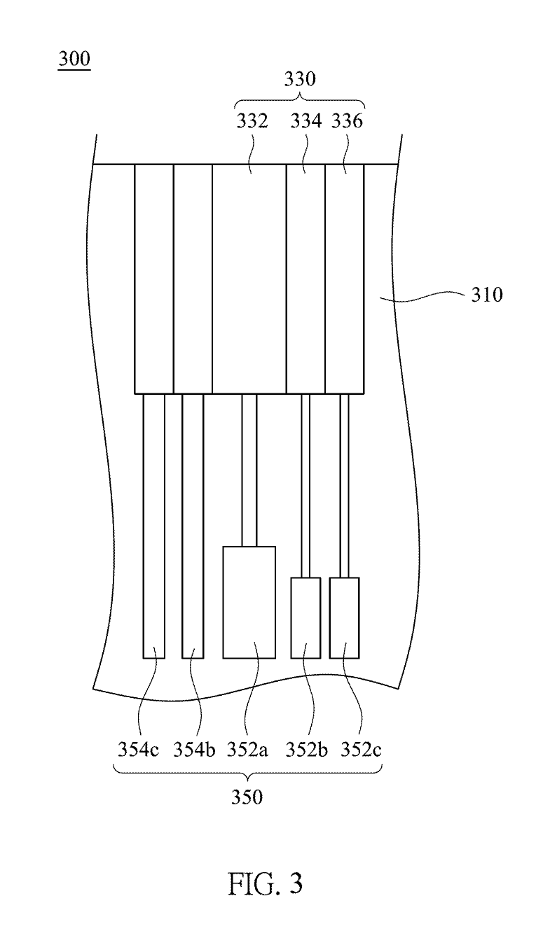

Referring to FIG. 2, which is a cross-sectional diagram of a part of a powder bed device 200 of additive manufacturing according to another embodiment of the present invention. The configuration of the powder bed device 200 is similar to that of the powder bed device 100, but difference therebetween is that a top plate 240 is disposed at a top portion of a powder bed platform 230, and the powder bed device 200 includes heating elements 260. An upper surface of the top plate 240 is configured to load a powder bed. Parts of the heating elements 260 are disposed within the powder bed platform 230 and adjacent to a lower surface of the top plate 240. The other parts of the heating elements 260 are disposed within the housing 210, locating beside the top plate 240 and adjacent to a top portion of the housing 210. In an embodiment, the heating elements 260 are heating coils and/or heating ducts.

In an embodiment, the top plate 240 is composed of plenty of top plate sections, so that the top plate 240 above each elevating platforms may move with ascent or descent of each elevating platform, and the heating elements 260 may also locate in different positions within the powder bed platform with the different heights of each elevating platform. It is understood that, the heating elements 260 within the housing 210 are fixed at the position adjacent to the top portion of the housing 210, but not controlled by the elevating devices 250. As a result, in the powder bed device 200, parts of the heating elements 260 may move to different positions by the elevating devices 250, such that the heating element 260 is not limited to perform pre-heating to a bottom portion of the powder bed. During the heating element is performing pre-heating to the bottom of the powder bed, the heating element can selectively pre-heat the side portion of the powder bed simultaneously, in which the side portion of the powder bed is pre-heated by the heating elements 260 within the adjoining elevating platform (i.e. non-descending elevating platform) or the housing 210.

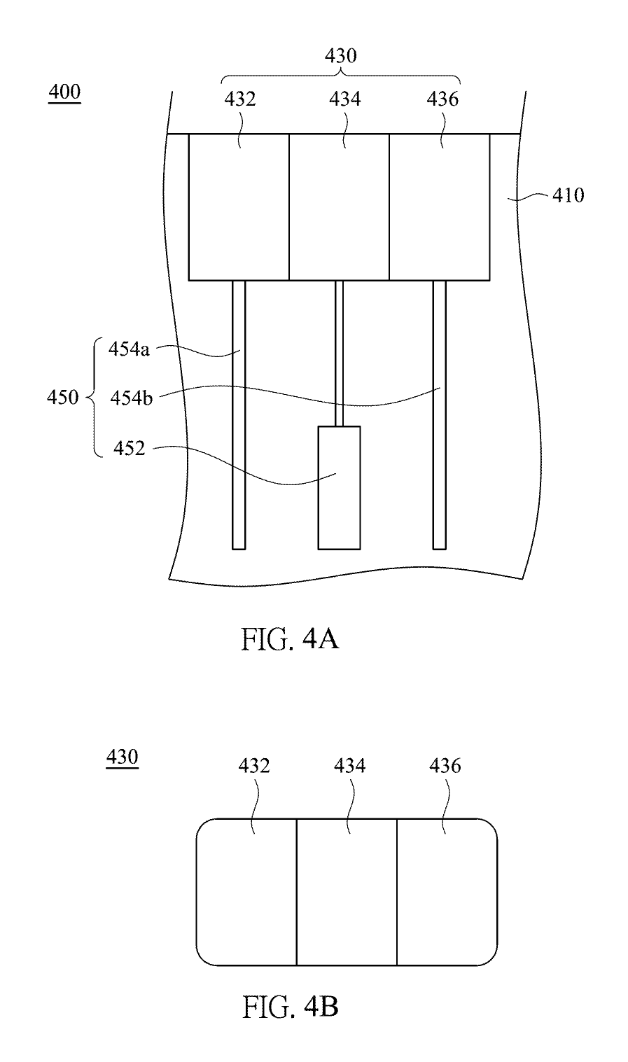

Referring to FIG. 3, which is a cross-sectional diagram of a part of a powder bed device 300 of additive manufacturing according to an embodiment of the present invention. The powder bed device 300 has similar structure as the powder bed device 100, and difference is that elevating devices 350 of the powder bed device 300 includes three transmission elements and two pneumatic cylinders. In an embodiment, a first transmission element 352a is connected to a bottom surface of a first elevating platform 332; a second transmission element 352b is connected to a bottom surface of one side of a second elevating platform 334, and a first pneumatic cylinder 354b is connected to a bottom surface of another side of the second elevating platform 334; a third transmission element 352c is connected to a bottom surface of one side of a third elevating platform 336, and a second pneumatic cylinder 354c is connected to a bottom surface of another side of the third elevating platform 336.

The configuration of the powder bed device 300 makes ascent or descent of the first elevating platform 332, the second elevating platform 334 and the third elevating platform 336 not being joint together. In other words, the height of the first elevating platform 332 is individually controlled by the first transmission element 352a, the height of the second elevating platform 334 is individually controlled by the second transmission element 352b, and the height of the third elevating platform 336 is individually controlled by the third transmission element 352c. As a result, the first elevating platform 332, the second elevating platform 334 and the third elevating platform 336 may ascend or descend individually, so that the first elevating platform 332, the second elevating platform 334 and the third elevating platform 336 may not configured with the overlapped portions of the powder bed 100 described above.

In another embodiment, a top plate is selectively disposed at a top portion of the powder bed platform 330 (not shown), and the powder bed device 300 may also include heating elements (not shown); that is, the configuration may be similar to the powder bed device 200. By this way, the powder bed device 300 may not only control the powder bed dimension of fill-up powders, but also perform pre-heating on the bottom portion and the side portions of the powder bed by the heating elements. Moreover, the powder bed device 300 may make the first elevating platform 332, the second elevating platform 334 and the third elevating platform 336 in different heights by the elevating devices 350 so as to increase variability of powders fill-up for additive manufacturing, and provide more adjustments of position of heating elements to decrease temperature gradient within the powder bed. For example, the powder bed device 300 may subject powder bed platform 330 to be stair-stepped, such that the first elevating platform 332 is lower than the second elevating platform 334, and the second elevating platform 334 is lower than the third elevating platform 336. In such case, the heating elements within the first elevating platform 332 may heat the bottom layer of the powder layer, the heating elements within the second elevating platform 334 may heat the middle layer of the powder layer, the heating elements within the third elevating platform 336 may heat the upper layer of the powder layer, and the heating elements within the housing 310 may heat the further upper layer of the powder layer.

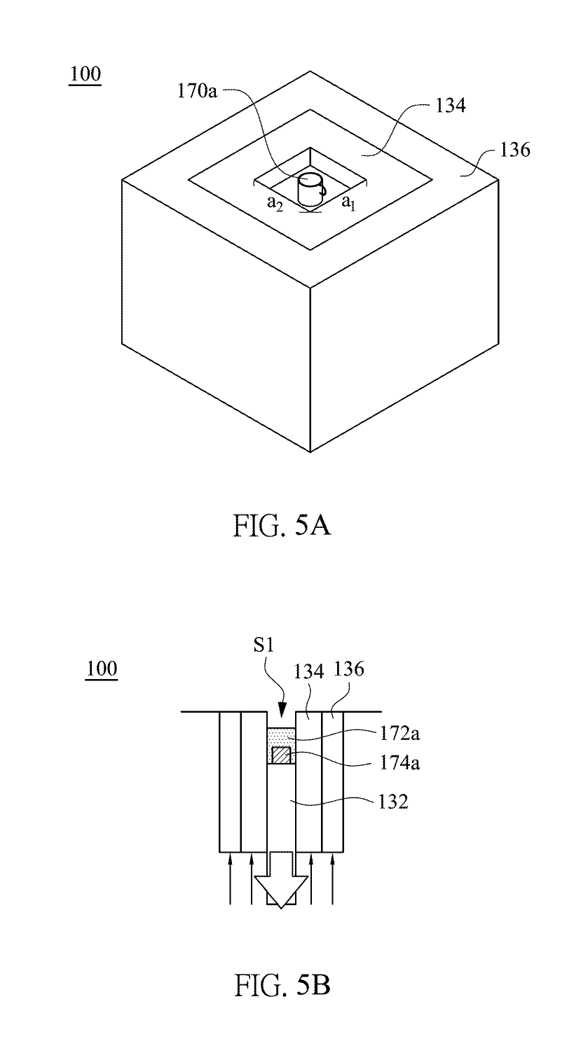

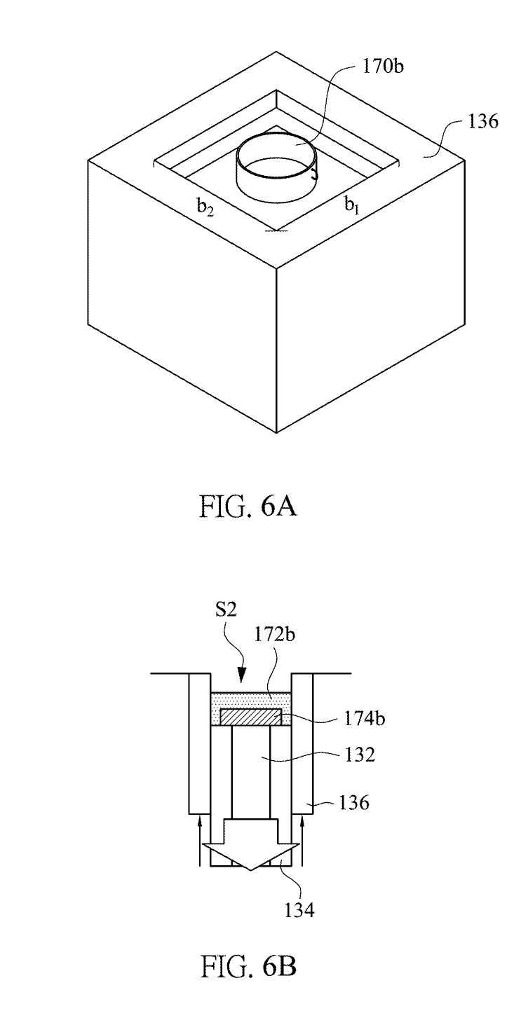

In an embodiment, the powder bed platform includes at least two elevating platforms, and each elevating platform at least adjoins other elevating platform. Referring to both FIG. 4A and FIG. 4B, FIG. 4A is a cross-sectional diagram of a part of a powder bed device 400 of additive manufacturing according to an embodiment of the present invention, and FIG. 4B is a top view of a powder bed platform 430 of the powder bed device 400 according to an embodiment of the present invention. Similarly, the powder bed platform 430 is disposed in the housing 410. As shown in FIG. 4A and FIG. 4B, the powder bed platform includes three elevating platforms, which are a first elevating platform 432, a second elevating platform 434 and a third elevating platform 436. The second elevating platform 434 adjoins the first elevating platform 432 and the third elevating platform 436, respectively. Similarly, the powder bed platform 430 and the elevating devices 450 may be both disposed in the housing 410. In an embodiment, the elevating devices 450 may be selectively disposed outside the housing 410.

As shown in FIG. 4A, the elevating devices 450 include a transmission element 452 and two pneumatic cylinders 454a and 454b, in which the transmission element 452 is connected to the second elevating platform 434, and a first pneumatic cylinder 454a and a second pneumatic cylinder 454b are connected to the first elevating platform 432 and the third elevating platform 436, respectively. In such example, overlapped portions are at adjoining positions between the first elevating platform 432 and the second elevating platform 434 and between the second elevating platform 434 and the third elevating platform 436, in which the overlapped portions are similar to the one shown in FIG. 1C. The first elevating platform 432 and the third elevating platform 436 can be jointly lifted or lowered with the second elevating platform 434 by the overlapped portions. In such embodiment, a top portion of the first elevating platform 432 and the third elevating platform 436 partially cover a top portion of the second elevating platform 434, respectively. Likewise, as FIG. 1A and FIG. 1C described above, the overlapped portion is so small that the overlapped portions are not shown in FIG. 4A for the sake of clarity of discussion. For example, when gas is introduced into the first pneumatic cylinder 454a, but not introduced into the second pneumatic cylinder 454b, the first elevating platform 432 is supported by the first pneumatic cylinder 454a with the introduced gas, and the third elevating platform 436 is not supported by gas, so that the third elevating platform 436 is jointly lifted or lowered with the second elevating platform 434 and the third elevating platform 436 align with the same height as the second elevating platform 434 (i.e. a top surface of the third elevating platform 436 is substantially coplanar with a top surface of the second elevating platform 434). In another embodiment, the elevating devices 450 may be three transmission elements, and the vertical ascent or the vertical descent of the first elevating platform 432, the second elevating platform 434, and the third elevating platform are not joint together, such that the heights of the elevating platforms may be controlled by the transmission elements individually. In an example, the transmission element 452 is an element including a motor, a lead screw, a linear guideway, and etc.

In another embodiment, a top plate is selectively disposed at a top portion of the powder bed platform 430 (not shown), and the powder bed device 400 may also include heating elements (not shown). Similar to the powder device 200, parts of the heating elements are disposed within the powder bed platform 430 and adjacent to a lower surface of the top plate. The other parts of the heating elements are disposed within the housing 410, locating beside the top plate and adjacent to a top portion of the housing 410. Likewise, in addition to the heating elements within the housing 410, the position of which are fixed, the other heating elements may locate at different positions of the powder bed platform 430 with ascent or descent of the powder bed platform 430, so as to perform pre-heating to a bottom portion and side portions of the powder bed simultaneously. In an example, the heating elements are heating coils and/or heating ducts.

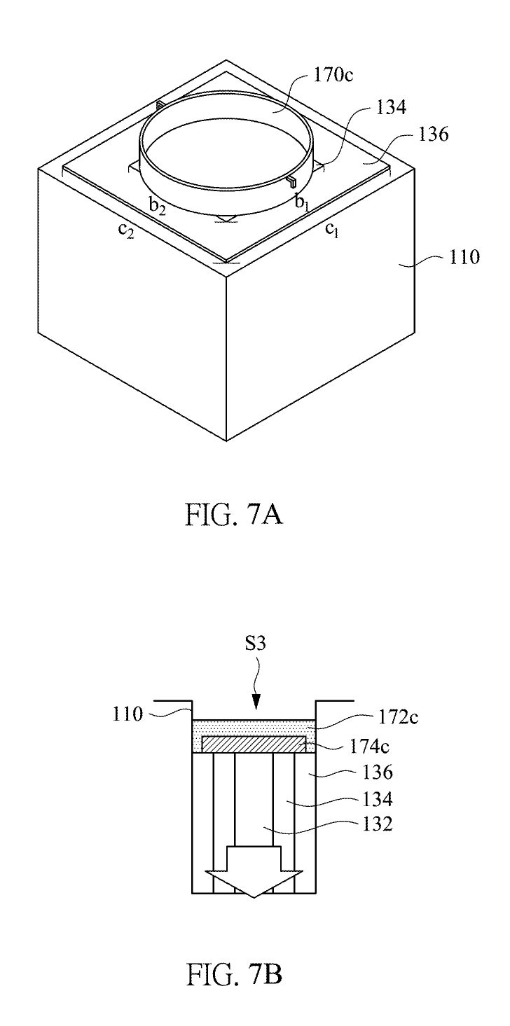

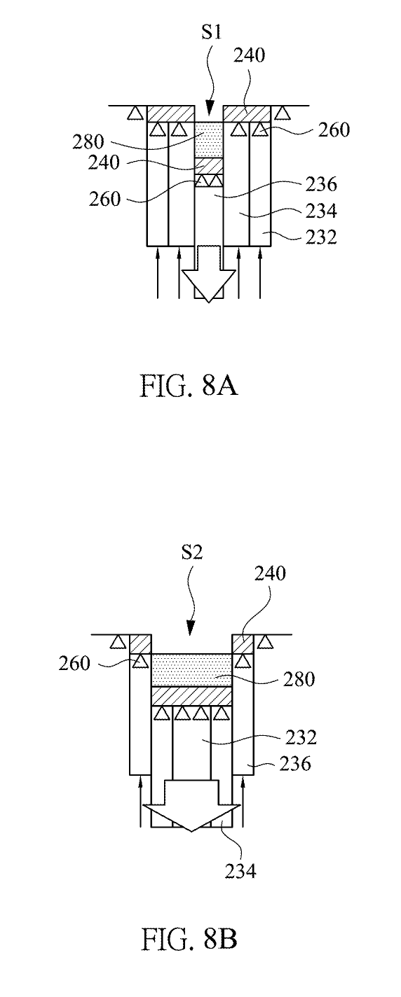

FIG. 5A, FIG. 6A and FIG. 7A are isometric views of the powder bed device 100 of FIG. 1A fabricating a workpiece. FIG. 5B, FIG. 6B and FIG. 7B are cross-sectional diagrams of the powder bed device 100 of FIG. 5A, FIG. 6A and FIG. 7A fabricating a workpiece. Operational method of the powder bed device 100 is discussed below with FIGS. 5A to 7B. In an embodiment, referring to FIG. 1A, FIG. 5A and FIG. 5B, each length of a desired workpiece 170a is smaller than side length a₁ and a₂ of the first elevating platform 132. In other words, the workpiece 170a can be placed in a recessed space S1 formed by descending the first elevating platform 132. Therefore, when additive manufacturing is performed, only the first elevating platform 132 is necessary to be descended, and gas is introduced into the first pneumatic cylinder 154a and the second pneumatic cylinder 154b to support the second elevating platform 134 and the third elevating platform 136. It is noted that, the recessed space S1 formed by descending the first elevating platform 132 is the space enclosed by the upper surface of the first elevating platform 132 and inner sidewalls of the second elevating platform 134. As a result, as shown in FIG. 5B, after a part 174a of the workpiece 170a is formed by an additive manufacturing process, the first elevating platform 132 is descended again, and powders 172a are filled up in the recessed space S1 formed by descending the first elevating platform 132 to continue the additive manufacturing process for an unfinished part of the workpiece 170a.

In another embodiment, referring to FIG. 1A, FIG. 6A and FIG. 6B, at least one length of a desired workpiece 170b is greater than side length a₁ and/or a₂ of the first elevating platform 132 (shown in FIG. 5A), and each length of the workpiece 170b is smaller than side length b₁ and b₂ of the second elevating platform 134. In other words, the workpiece 170b cannot be placed in the recessed space S1 formed by descending the first elevating platform 132, but it can be placed in a recessed space S2 formed by descending both the first elevating platform 132 and the second elevating platform 134. Therefore, when additive manufacturing is performed, gas is not introduced into the first pneumatic cylinder 154a to make the first elevating platform 132 and the second elevating platform 134 be jointly descended, and gas is introduced into the second pneumatic cylinder 154b to support the third elevating platform 136. Similar to the above, the recessed space S2 formed by descending both the first elevating platform 132 and the second elevating platform 134 is the space enclosed by the upper surface of the first elevating platform 132 and the second elevating platform 134 and inner sidewalls of the third elevating platform 136. As a result, as shown in FIG. 6B, after a part 174b of the workpiece 170b is formed by an additive manufacturing process, the first elevating platform 132 and the second elevating platform 134 are descended again, and powders 172b are filled up in the recessed space S2 formed by descending the first elevating platform 132 and the second elevating platform 134 to continue the additive manufacturing process for an unfinished part of the workpiece 170b.

In further another embodiment, referring to FIG. 1A, FIG. 7A and FIG. 7B, at least one length of a desired workpiece 170c is greater than side length b₁ and/or b₂ of the second elevating platform 134, and each length of the workpiece 170c is smaller than side length c₁ and c₂ of the third elevating platform 136. In other words, the workpiece 170c cannot be placed in the recessed space S2 formed by descending the first elevating platform 132 and the second elevating platform 134, but it can be placed in a recessed space S3 formed by descending the first elevating platform 132, the second elevating platform 134, and the third elevating platform 136. Therefore, when additive manufacturing is performed, gas is not introduced into the first pneumatic cylinder 154a and the second pneumatic cylinder 154b to make the first elevating platform 132, the second elevating platform 134 and the third elevating platform 136 be jointly descended. Similar to the above, the recessed space S3 formed by descending the first elevating platform 132, the second elevating platform 134 and the third elevating platform 136 is the space enclosed by the upper surface of the first elevating platform 132, the second elevating platform 134, and the third elevating platform 136 and inner sidewalls of the housing 110. As a result, as shown in FIG. 7B, after a part 174c of the workpiece 170c is formed by an additive manufacturing process, the first elevating platform 132, the second elevating platform 134, and the third elevating platform 136 are descended again, and powders 172c are filled up in the recessed space S3 formed by descending the first elevating platform 132, the second elevating platform 134, and the third elevating platform 136 to continue the additive manufacturing process for an unfinished part of the workpiece 170c.

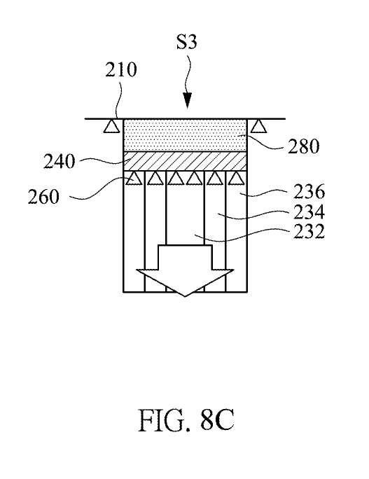

FIG. 8A, FIG. 8B and FIG. 8C are cross-sectional diagrams of the powder bed device 200 of FIG. 2 fabricating a workpiece. In addition to adjust powder bed platform according to dimensions of the desired workpiece as FIG. 5B-7B do, the powder bed device 200 with heating elements 260 may also adjust the powder bed platform 230 according to height of the desired workpiece so as to decrease temperature gradient between an upper layer and a lower layer of a powder layer 280.

In an embodiment, referring to FIG. 2 and FIG. 8A, when a desired workpiece can be placed in the recessed space S1, and height of the workpiece is higher, during performing the additive manufacturing, only the first elevating platform 232 is necessary to be descended, and gas is introduced into the first pneumatic cylinder 254a and the second pneumatic cylinder 254b to support the second elevating platform 234 and the third elevating platform 236. Therefore, the heating elements 260 within the first elevating platform 232 may perform pre-heating to the bottom portion of the powder layer 280, and the heating elements 260 within the second elevating platform 234 and the third elevating platform 236 may perform pre-heating to the side portion of the upper layer of the powder layer 280. As a result, the configuration of the embodiment provides more benefit for manufacturing the workpiece with higher height in that the temperature gradient between the upper layer and the lower layer of the powder layer is particularly significant by the conventional method for manufacturing the workpiece with higher height, and quality of the desired workpiece is often poor. However, the powder bed device 200 may decrease the temperature gradient between the upper layer and the lower layer of the powder layer 280 by heating elements 260, thereby effectively improving the quality of the workpiece.

In another embodiment, referring to FIG. 2 and FIG. 8B, when a desired workpiece cannot be placed in the recessed space Si but can be placed in a recessed space S2, and the workpiece has a higher height, during performing the additive manufacturing, gas is not introduced into the first pneumatic cylinder 254a to make the first elevating platform 232 and the second elevating platform 234 be jointly descended, and gas is introduced into the second pneumatic cylinder 254b to support the third elevating platform 236. Therefore, the heating elements 260 within the first elevating platform 232 and the second elevating platform 234 may perform pre-heating to the bottom portion of the powder layer 280, and the heating elements 260 within the third elevating platform 236 may perform pre-heating to the side portion of the upper layer of the powder layer 280. For manufacturing the desired workpiece with a higher height, besides performing pre-heating to the bottom portion of the powder layer 280 by the heating elements 260, the other parts of the heating elements 260 may perform pre-heating to the side portion so as to improve the temperature gradient between the upper layer and the lower layer of the powder layer 280.

In further another embodiment, referring to FIG. 2 and FIG. 8C, when a workpiece cannot be placed in the recessed space S2 but can be placed in a recessed space S3, during performing the additive manufacturing, gas is not introduced into the first pneumatic cylinder 254a and the second pneumatic cylinder 254b to make the first elevating platform 232, the second elevating platform 234 and the third elevating platform 236 be jointly descended. Therefore, the heating elements 260 within the first elevating platform 232, the second elevating platform 234, and the third elevating platform 236 may perform pre-heating to the bottom portion of the powder layer 280, and the heating elements 260 within the housing 210 may perform pre-heating to the side portion of the upper layer of the powder layer 280, such that the temperature gradient between the upper layer and the lower layer of the powder layer 280 may be decreased.

In an embodiment, additive manufacturing apparatus includes the powder bed device discussed above, a distributor disposed on the powder bed device and a laser source. When performing additive manufacturing process, powders are filled up on the top surface of the powder bed platform of the powder bed device. Then, the powders are distributed evenly on the top surface of the powder bed platform by the distributor, and the laser source provides energy to the powder bed to perform sintering. After sintering, the specific powder bed platform is descended to repeat steps of filling up the powders, distributing the powders and sintering until the workpiece is produced. Also, in this embodiment, the powder bed device may include the heating elements selectively, thereby performing pre-heating to the bottom portion and the side portion of the powder layer by the heating elements.

A powder bed device of additive manufacturing is provided. Height of elevating platforms of a powder bed platform may be adjusted by elevating devices, which are connected to the elevating platform. Therefore, the filled range (i.e. the filled volume) of powders may be controlled, thereby avoiding waste of the excess powder. Moreover, positions of heating elements may also be controlled so as to decrease temperature gradient between multilayer of a powder layer, and quality of a workpiece may be improved.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A powder bed device of an additive manufacturing, comprising:
a housing;
a powder bed platform disposed in the housing, the powder bed platform is configured to load a powder bed, the powder bed includes a plurality of powders, wherein the powder bed platform includes at least two elevating platforms, each of the elevating platforms at least adjoins the other one of the elevating platforms, and the elevating platforms are linked or not linked to each other; and
a plurality of elevating devices connected to a bottom surface of each of the elevating platforms, respectively.

2. The powder bed device of claim 1, wherein the powder bed platform is a combined annular platform, and the elevating platforms include:
a first elevating platform located at a center portion of the powder bed platform; and
a second elevating platform enclosed an outer sidewall of the first elevating platform.

3. The powder bed device of claim 1, wherein a top plate is disposed at a top portion of the powder bed platform, and the powder bed device further comprises:
a plurality of heating elements disposed within the powder bed platform and the housing, wherein the heating elements are adjacent to the top plate or a top portion of the housing.

4. The powder bed device of claim 3, wherein the heating elements are heating coils and/or heating ducts.

5. The powder bed device of claim 1, wherein the adjoining elevating platforms have an overlapped portion to jointly and vertically lift or lower the adjoining ones.

6. The powder bed device of claim 1, wherein the elevating devices include at least one transmission element and at least one pneumatic cylinder.

7. A powder bed device of an additive manufacturing, comprising:
a housing;
a powder bed platform disposed in the housing, the powder bed platform is configured to load a powder bed, the powder bed includes a plurality of powders, wherein the powder bed platform includes:
a first elevating platform; and
a second elevating platform enclosed an outer sidewall of the first elevating platform, the second elevating platform includes a plurality of sub-elevating platforms, wherein one of the sub-elevating platforms encloses other one of the sub-elevating platforms, and a distance between the one and the first elevating platform is greater than a distance between the other one and the first elevating platform;
a transmission element connected to a bottom surface of the first elevating platform; and
a plurality of pneumatic cylinders connected to a bottom surface of each of the sub-elevating platforms of the second elevating platform, respectively.

8. The powder bed device of claim 7, wherein the first elevating platform and the second elevating platform have an overlapped portion to jointly and vertically lift and lower the first elevating platform and the second elevating platform, and the adjoining sub-elevating platforms of the second elevating platform have other overlapped portions to jointly and vertically lift and lower the adjoining ones.

9. The powder bed device of claim 7, wherein a top plate is disposed at a top portion of the powder bed platform, and the powder bed device further comprises:
a plurality of heating elements disposed within the powder bed platform and the housing, wherein the heating elements are adjacent to the top plate or a top portion of the housing.

10. The powder bed device of claim 9, wherein the heating elements are heating coils and/or heating ducts.

11. An additive manufacturing apparatus, comprising:
a powder bed device, including:
a housing;
a powder bed platform disposed in the housing, the powder bed platform is configured to load a powder bed, the powder bed includes a plurality of powders, and the powder bed platform includes at least two elevating platforms, each of the elevating platforms at least adjoins the other one of the elevating platforms, the elevating platforms are linked or not linked to each other; and
a plurality of elevating devices connected to a bottom surface of each of the elevating platforms, respectively;
a distributor disposed on the powder bed device for distributing the powders on a top surface of the powder bed platform evenly; and
a laser source for providing a laser energy to the powder bed.

12. The additive manufacturing apparatus of claim 11, wherein a top plate is disposed at a top portion of the powder bed platform, and the powder bed device further comprises:
a plurality of heating elements disposed within the powder bed platform and the housing, wherein the heating elements are adjacent to the top plate or a top portion of the housing.

13. The additive manufacturing apparatus of claim 12, wherein the heating elements are heating coils and/or heating ducts.

14. The additive manufacturing apparatus of claim 11, wherein the powder bed platform is a combined annular platform, and the elevating platforms include:
a first elevating platform located at a center portion of the powder bed platform; and
a second elevating platform enclosed an outer sidewall of the first elevating platform.

15. The additive manufacturing apparatus of claim 11, wherein the elevating devices include at least one transmission element and at least one pneumatic cylinder.
